(19) United States
(12) Patent Application Publication
(10) Pub. No.: US 2009/0212251 A1
(43) Pub. Date: Aug. 27, 2009

(54) Methods and compositions for extinguishing fires using aqueous gelled fluids

(76) Inventor: Robert Stewart Taylor, Calgary (CA)

Correspondence Address: Robert Stewart Taylor, 105 Rockbluff Place N.W., Calgary Alberta, T3G5B1, CA

(21) Appl. No.: 11/631,413

(22) PCT Filed: Sep. 14, 2005
(86) PCT No.: PCT/CA05/01404

§ 371 Date: Jan. 3, 2007

(30) Foreign Application Priority Data
Sep. 20, 2004 (CA) 2479653

(51) Int. Cl. A62D 1/00

(52) U.S. Cl. 252/2

(57) ABSTRACT

The present invention relates to improved methods of extinguishing fires or retarding fire propagation by forming a crosslinked water gel which is then applied to the fire or area to be protected. By forming a semi-solid crosslinked gel water can be conveyed over large distances while minimizing losses due to misting, thus making fire fighting from great distances possible and improving the efficiency of aerial drops. The crosslinked gel also has a particularly good adhesiveness and cohesiveness, giving it the ability to form one continuous blanket on the ground thereby smothering the fire and preventing re-ignition. The combination of these properties makes the crosslinked gel ideal for applications such as control and extinguishing of forest fires. In addition, the composition may include additional active ingredients such as herbicide, pesticide, fungicide fertilizer, or the like for soil remediation after the fire is extinguished.

### BACKGROUND OF THE INVENTION

1. Field of the Invention

The present invention relates to improved methods of extinguishing fires or retarding fire propagation by forming a crosslinked water gel which is then applied to the fire or area to be protected. By forming a semi-solid crosslinked gel water can be conveyed over large distances while minimizing losses due to misting, thus making fire fighting from great distances possible and improving the efficiency of aerial drops. The crosslinked gel also has a particularly good adhesiveness and cohesiveness, giving it the ability to form one continuous blanket on the ground thereby smothering the fire and preventing re-ignition. The combination of these properties makes the crosslinked gel ideal for applications such as control and extinguishing of forest fires. In addition, the composition may include additional active ingredients such as herbicide, pesticide, fungicide fertilizer, or the like for soil remediation after the fire is extinguished.

2. Description of the Prior Art

Water Bombers and Helicopters with water buckets are commonly used to dispense water on Forest Fires as a method of extinguishing the fire. However, due to the extreme heat, air turbulence, strong updrafts over the fire, and the distance the water must fall, a significant portion of water is lost to evaporation before reaching the inflamed material.

As a result a critical limitation of the current art is that water must be dropped within close proximity of the fire. This restricts operations in conditions of low visibility and prevents operations at night. During this time the fire can grow substantially. The need to drop water from a low altitude in close proximity to the fire is also a severe safety risk.

Similar problems are experienced when spraying or jetting water onto fires such as is done when extinguishing home and industrial fires. The water stream breaks into fine droplets over distance which limits the distance it can travel and increases the loss to evaporation.

One of the key factors leading to evaporation is that the water can become dispersed as a fine mist of water droplets while falling or after being pumped out of a nozzle or jet. The increased surface area of water exposed to the superheated air results in a significant increase in the rate of evaporation.

A number of patents listed below attempt to address these limitations by adding a polymer to the water to form a gel, or through addition of surfactants to form foam. These additions help to reduce the extent of the problems experienced with water alone by increasing the viscosity and elastic properties of the fluid. However, the prior art does teach the combination of polymers and crosslinkers disclosed in CA 2,479,653. Through this combination it is possible to increase viscosity by an order of magnitude over that of a gel or foam alone. Also, through addition of a crosslinker, the gel takes on elastic properties causing it to behave as one cohesive semi-solid mass.

Canadian Patents
Title: FIRE EXTINGUISHING AND PROTECTION AGENT
Patent Number: CA 2101947
Publication Date: Aug. 20, 1992
Inventor: BUIL, JURGEN LOHNERT, GERNOT
Title: FIRE-EXTINGUISHING AGENT, WATER FOR FIRE EXTINGUISHING, AND METHOD OF FIRE EXTINGUISHING
Patent Number: CA 2413152
Publication Date: Oct. 31, 2002
Inventor: KOMATSU, SHIGERU; MARUYAMA, TAKASHI; SUMITANI, MASATOSHI; WANG, YANFENG; SAKAE, KOJIRO; KASHIKI, KEIZOU
Title: LIQUID FOAM EXTINGUISHING AGENT
Patent Number: (11) CA 1252959 (21) 476562
Issued: Apr. 25, 1989
Inventor: CORDES, HILDA (Germany (Federal Republic of)) ACHILLES, ERNST (Germany (Federal Republic of))
Title: PROCESS FOR THE PREPARATION OF A SODIUM POLYACRYLATE GEL
Patent Number: CA 2018075
Publication Date: Dec. 2, 1990
Inventor: TEROL CARBONELL, JORGE (Spain) TEROL CARBONELL, JORGE (Spain)
Title: POLYSACCHARIDE/PERFLUOROALKYL COMPLEXES
Patent Number: (11) CA 1308098 (21) 579564
Issued: Sep. 29, 1992
Inventor: CLARK, KIRTLAND P. (United States) FALK, ROBERT A. (United States)
Title: COMPOSITION FOR APPLICATION TO A SOIL OR PLANT LOCUS
Patent Number: CA 1308929 (21) 567096
Issued: Oct. 20, 1992
Inventor: BEWSEY, JOHN A. (South Africa)
Title: FOAM FIRE EXTINGUISHING COMPOSITION FOR AERIAL FIRE EXTINGUISHING
Patent Number: (11) CA 1296172 (21) 541358
Issued: Feb. 25, 1992
Inventor: COWAN, GEORGE (Canada) CUNDASAWMY, EDWARD (Canada)

United States Patents
Title: Fire extinguishing and protection agent
U.S. Pat. No.: 5,518,638
Issue Date: May 21, 1996
Inventor: Buil; Jurgen (Heldstrasse 19, Kleve, DE); Lohnert; Gernot (Rottweg 16, Hamminkeln, DE)
Title: Method for reducing the aerial drift of aqueous preparations
U.S. Pat. No.: 4,610,311
Issue Date: Sep. 9, 1986
Inventor: Bronner; James A. (Glendale, Calif.); Moore; John D. (Los Angeles, Calif.); Dale; Paul R. (La Crescenta, Calif.)
Title: Fire retardant foam and gel compositions
Patent Number: US2005127338
Publication Date: 16 Jun. 2005
Inventor: FIGIEL EDMUND W (US); BYRNE ROBERT E (US); ORLOFF JOHN E (US); NASS DAVID R (US)
Title: Fire retardant foam and gel compositions
Patent Number: TW589357
Publication Date: 2004 Jun. 01
Inventor: FIGIEL EDMUND W (US); BYRNE ROBERT E (US); ORLOFF JOHN E (US)
Title: Fire-resistant gel pads
U.S. Pat. No.: 6,080,462
Publication Date: 27 Jun. 2000
Inventor: GORDAN RONALD
Title: Fire protection water barrier which is a gel composition of high water content and high viscosity

U.S. Pat. No.: 4,384,988
Issue Date: May 24, 1983
Inventor: Schoenholz; Daniel (Basking Ridge, N.J.); Parisek; Charles B. (Morristown, N.J.)

European Patents
Title: FIRE-RETARDING GLASSES FORMED FROM GLASS PANES AND GEL LAYERS IN A SANDWICH-LIKE STRUCTURE
Patent Number: SG108869
Publication Date: 2005 Feb. 28
Inventor: KLAUS SCHNEIDER; KLAUS-DIETER SCHWABE; GERRIT PANZNER
Title: High water absorption resin water suction gel fire extinguisher and its application
Patent Number: CN1557516
Publication Date: 2004 Dec. 29
Inventor: SUN WEILIN (CN); ZHU LUTONG (CN)
Title: Gel-forming fire-extinguishing system
Patent Number: NL1007738C
Publication Date: 9 Jun. 05
Inventor: TURNHOUT JAN VAN (NL); SCHULPEN WALBERT RICHARD (NL); LAW JAMES ROBERT (NL); SCHMIT GUIDO BERNARD (NL)
Title: Method of transforming water into a gel and gel forming agent for water for various purposes such as fire-extinguishing
Patent Number: GB1004102
Publication Date: 1965 Sep. 08
Inventor: NILS EMIL WANNBORG; GUSTAV LINDGREN
Title: Treating water used for combating fire—by adding crosslinked polyacrylate or polyacrylamide to form gel
Patent Number: FR2628976
Publication Date: 29 Sep. 1989
Inventor: WEBER ADOLPHE
Title: FIRE EXTINGUISHING GEL
Patent Number: JP10192444
Publication Date: 28 Jul. 1998
Inventor: SHIOJI NAOTAKE; OKAMURA KAZUHIRO; GOTOU ERI
Title: PRODUCTION OF FIRE-RETARDANT ORGANIC SOLVENT GELLING AGENT
Patent Number: JP56158139
Publication Date: 5 Dec. 1981
Inventor: TAKAGI SHIGEYUKI; SHIROSHIKI NORIO; NAKASHIMA TOORU; YAMAMOTO NQRIKO; IWASE SHIYOUJI
Title: PRODUCTION OF HIGHLY WATER-ABSORBING RESIN
Patent Number: JP57080403
Publication Date: 20 May 1982
Inventor: YAMAMOTO YASUO; IWATA HIROO

### SUMMARY OF THE INVENTION

The present invention relates to improved methods of extinguishing fires or retarding fire propagation by forming a crosslinked water gel which is then applied to the fire or area to be protected.

The crosslinked water gel comprises among other things water, a water soluble polymer, and a crosslinking agent.

Polymers which could be used to form a crosslinked gel include polymers with crosslinking sites such as cis-hydroxyl and carboxyl functionalities. Included are Guar and Guar Derivatives such as Hydroxy Propyl Guar and Carboxy Methyl Hydroxy Propyl Guar, Starch, Cellulostic Polymers derivatized with Carboxyl Groups such as Carboxy Methyl Hydroxy Ethyl Cellulose, and Acrylamide derivatives.

Crosslinking agents include zirconates, titanates, chromates, antimonates, borates and ferric iron.

In another embodiment, the present invention provides a method of preparing crosslinked gels for both batch mix and continuous mix applications.

Batch mix applications are those in which all chemicals are added to the water to form the gel or crosslinked gel before it is loaded onto the aircraft which will be used to dispense it.

Continuous mix applications are those in which some or all chemicals are added to the water while it is being pumped. This could include operations where gelled fluid is loaded onto an aircraft or is pumped directly onto a fire or area one wishes to impart fire retardant properties to.

The objects, features and advantages of the present invention will be readily apparent to those skilled in the art upon a reading of the description of the preferred embodiments which follow.

### DESCRIPTION OF PREFERRED EMBODIMENTS

The present invention relates to improved methods of extinguishing fires or retarding fire propagation by forming a crosslinked water gel which is then applied to the fire or area to be protected.

The most preferred embodiment is a crosslinked gel comprised of:

Water

0.300% Guar Gum

0.080 wt % Sodium Carbonate

0.020 wt % Fumaric Acid

0.0225 wt % Sodium Borate Decahydrate

Recommended fertilizers for area of application

Gels can be batch or continuous mixed. In batch mix applications all chemicals are added to the water before pumping. In continuous mix operations some or all of the chemicals are added to the water while it is being pumped onto the fire or area one wishes to impart fire retardant properties to.

For a batch mixed application the chemicals would be mixed in the following order:

BASE GEL

Water

0.020 kg/m³ of water Sodium Carbonate

0.300 kg/m³ of water Guar Gum

0.020 kg/m³ of water Fumaric Acid

Mix for 20 minutes

0.060 kg/m³ of water sodium carbonate (Final pH 9.8 to 10.0)

Add while pumping above base gel

2.0 L/m³ of solution containing:
112.5 kg Sodium Borate Decahydrate/1000 Litre total volume. Make by dissolving 112.5 kg. Sodium Borate Decahydrate in a sufficient volume of the following solvent system to give exactly one thousand Litres total volume:
   67 wt % glycerol
   33 wt % water
Use of this solvent system not only provides an excellent medium for dissolving sodium borate decahydrate but also provides a pour point of<−40C using environmentally friendly chemicals.

For a continuous mix application the chemicals would be mixed in the following order:

1 m3 Water

6.0 L/m3 of Slurry of Guar Gum in Vegetable Oil containing:
500 kg Guar Gum
641 Litres Vegetable Oil
Total Volume of 1000 litres
   Note: The Guar Gum slurry can be stabilized through addition of common oil viscosifiers such as hydrophobic clays, typically used at 3 wt % based on weight of slurry. Other oil viscosifiers include iron and aluminum complexes of phosphonate and phosphate esters. Polymethacrylate type viscosifiers may also be used.

Add after five minutes hydration
2.0 L/m3 of 112.5 kg/m³ Sodium Borate
Decahydrate in following solvent system:
   67 wt % glycerol
   33 wt % water

The water utilized in the water-based gel compositions of the present invention can be fresh water, salt water (e.g., water containing one or more salts dissolved therein), brine (e.g., saturated salt water), or seawater. Generally, the water can be from any source provided that it does not contain an excess of compounds that may adversely affect other components in the gel composition. One should be mindful of the composition of the water as certain components may negatively affect the performance or ability to form a gel. Components such as calcium, magnesium, and ferric iron may be problematic if present in the water in a sufficient concentration to cause crosslinking themselves at alkaline pH. Bacteria present in the water might also result in enzyme formation and resultant degradation of a base gel during storage if some form of bactericide were not also added. Such bactericides include inter alia aldehydes, amines, quaternary amines, compounds with a thio functionality, and oxidizers such as hypochlorite and peroxide. One of ordinary skill in the art with the benefit of this disclosure will recognize other compounds that may negatively interfere with the gel formation that should be minimized in the water component of the composition. Such a person will also recognize the need for biocides to be present in base gels stored for extended periods and for storage tanks to be lined such that iron is not introduced into the gel through corrosion of bare metal.

In applications involving extinguishing of fires on forested areas or agricultural lands it may be desirable to use fresh water to promote re-growth.

To demonstrate the teachings of the present invention, the following examples of preferred embodiments are given. In no way should such examples be read to limit the scope of the invention.

### EXAMPLE

### Comparison of Crosslinked Gelled Water vs. Ungelled Water for Extinguishing a Wood Fire

Step 1: Two Litres of the following Crosslinked Water Fluid was Prepared:
3.0 kg/m3 H.P. Guar
Adjust pH to 8.5 with Sodium Carbonate
Add 5.0 L/m3 of 25 g/100 ml solution of Sodium Borate Decahydrate in following solvent system:
   67 wt % glycerol
   33 wt % water

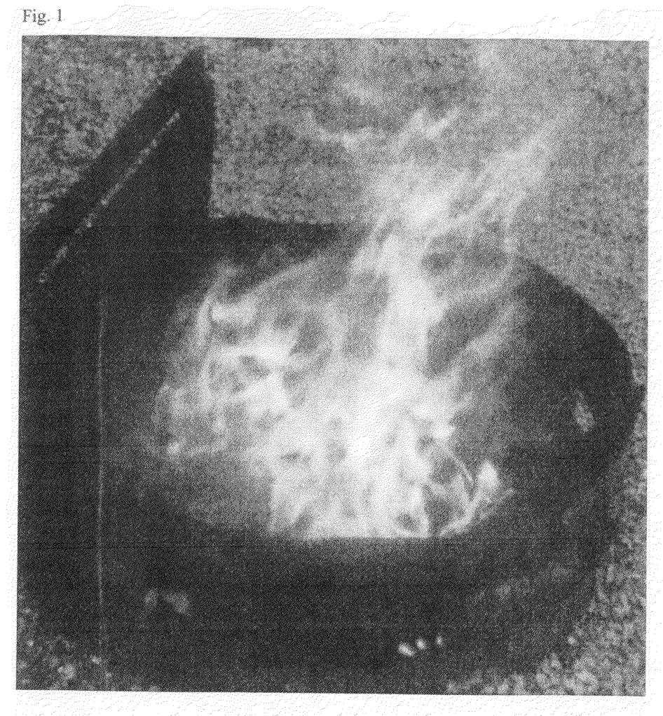

Step 2: A wood fire was built in a 1 metre diameter fire pit using chopped pieces of birch wood to provide a source of fire. (FIG. 1)

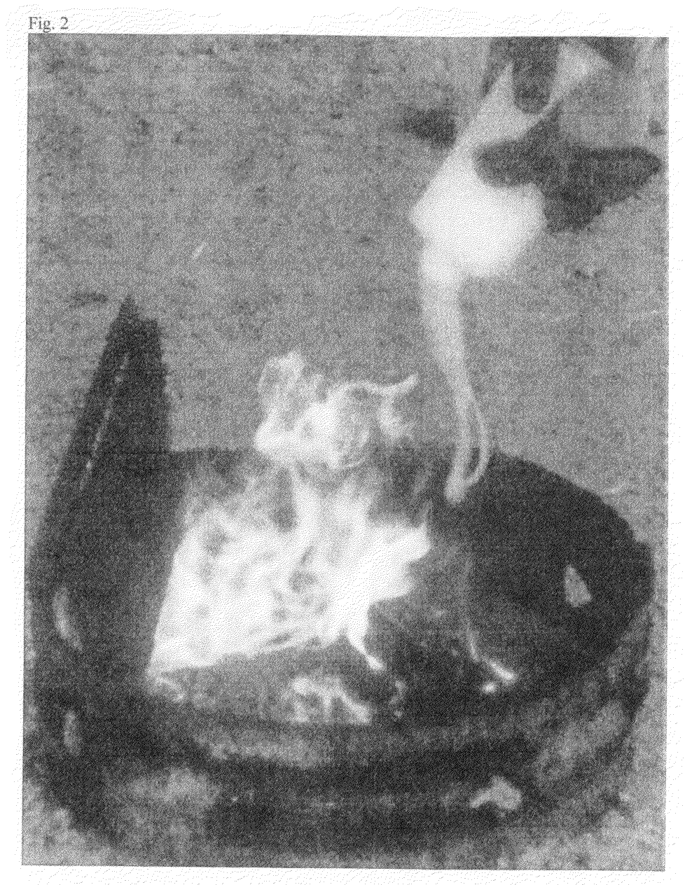

Step 3: Two litres of the crosslinked gel described in paragraph 033 was poured onto one half of the fire from above the flames. (FIG. 2)

The gel extinguished the fire in the area contacted. The fire in the uncontacted area continued to burn. (FIG. 3)

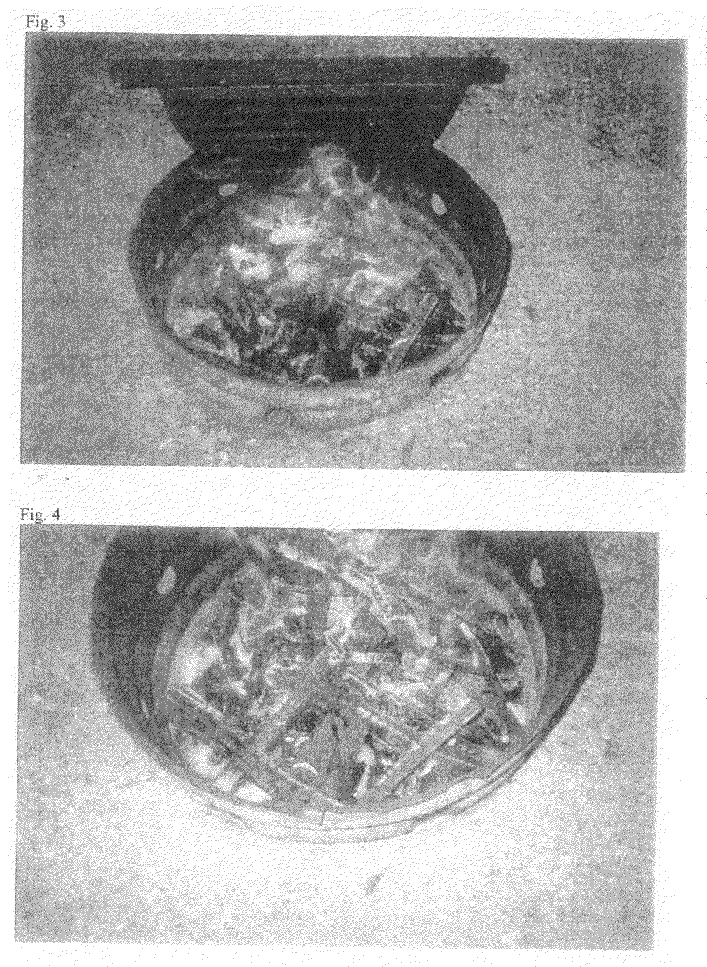

After five minutes the area contacted by crosslinked gel had still not reignited. (FIG. 4)

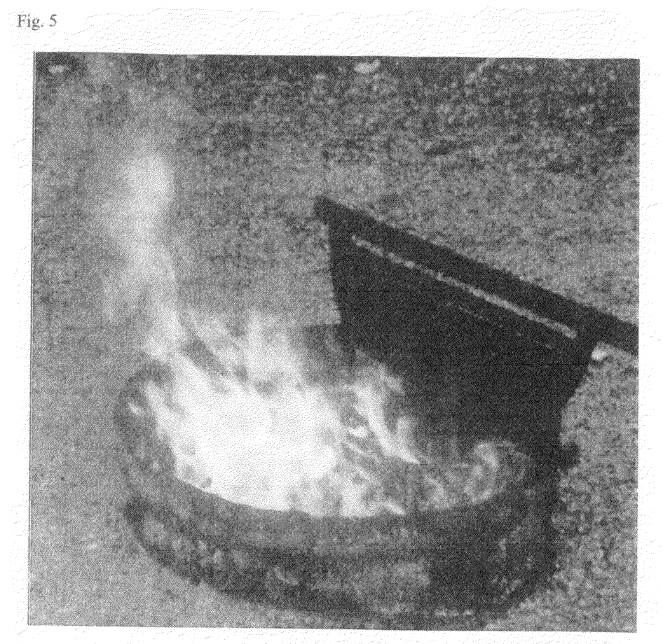

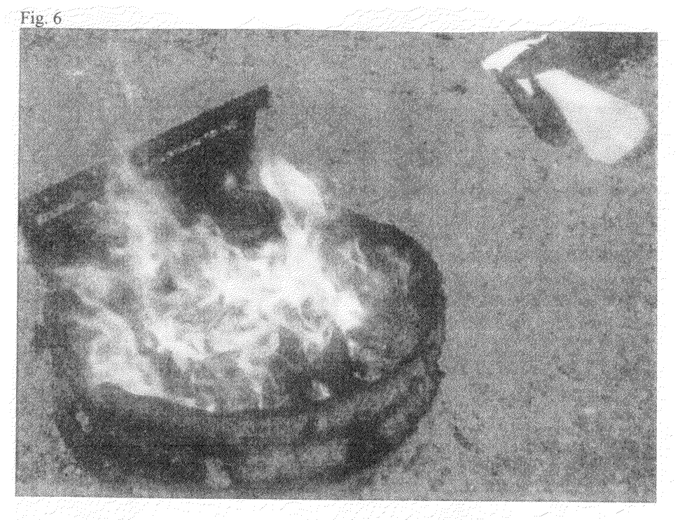

Step 4: The fire was rebuilt by adding wood over a 20 minute time period, to the same condition it was in before the addition of the crosslinked water gel. (FIG. 5)

Step 5: Two litres of water was added to the fire by spraying it as fine mist from above the fire using a water spray bottle. In this instance the addition of the water had no significant effect in retarding or extinguished the flames. A lot of the water was lost to evaporation in the flames before reaching the source of the fire, the burning wood below. (FIG. 6)

The crosslinked water gel very effectively starves the fire for oxygen once it falls on the inflamed material. It in effect forms an impermeable blanket over the inflamed material, preventing oxygen from reaching the source of the fire. This in turn stops the oxidation reaction which propagates the fire, preventing further combustible material from becoming inflamed and allowing the already inflamed material to begin cooling.

The cool gel also helps to extract heat from the inflamed material due to the high specific heat of water.

The chemicals used are environmentally friendly. By combining fertilizer with the crosslinked gel, the gel not only extinguishes the fire but helps prepare the ground for future growth.

Thus, the present invention is well adapted to carry out the objects and attain the ends and advantages mentioned as well as those which are inherent therein. While numerous changes may be made by those skilled in the art, such changes are encompassed within the spirit and scope of this invention as defined by the appended claims.

What is claimed is:

1. A method of extinguishing a fire or of imparting fire retardant properties by adding a water-based composition containing among other things a gelling agent and a metal ion crosslinker.

2. The method of claim 1 wherein the gelling agent comprises guar gum, hydroxy propyl guar gum, carboxy methyl hydroxypropyl guar gum, hydroxyethyl cellulose, carboxy methyl cellulose, carboxy methyl, hydroxyethyl cellulose, polyacrylamides, polyacrylates, polyethylene oxide, starch, or starch derivatives.

3. The method of claim 1 wherein the gelling agent is added in a concentration between 0.1 wt % and 10 wt %.

4. The method of claim 1 wherein the metal ions are ions of boron, zirconium, titanium, aluminum, chrome, ruthenium, lanthanide, or iron.

5. The method of claim 1 wherein the water in the water-based gel composition comprises fresh water, salt water, brine, or seawater.

6. The method of claim 1 wherein water is present in the water-based gel composition in an amount in the range of from about 90% to about 99.9% by weight of the composition.

7. The method of claim 1 wherein the water-based gel composition further comprises chemicals used as fertilizer for soil which comprise among other things phosphorus, nitrogen, and sulfur.

8. The method of claim 1 wherein the water-based gel composition further comprises a gel breaker.

9. The method of claim 8 wherein the gel breaker comprises enzymes, reducing agents, pH adjustment chemicals, esters for delayed acid formation, oxidizing agents, or oxidizing agents in combination with a catalyst.

10. The method of claim 8 wherein the breaker is formulated to provide a delayed reversal of crosslinking and/or a reduction in polymer molecular weight with a resultant reduction in gel viscosity.
